(19) United States
(12) Patent Application Publication
(10) Pub. No.: US 2010/0006669 A1
(43) Pub. Date: Jan. 14, 2010

(54) Self setting sprinkler riser

(76) Inventor: Bruce A. Thompson, Granite Bay, CA (US)

Correspondence Address: Dr. Bruce A. Thompson, 6700 Auburn Folsom Road, Granite Bay, CA, 95746, US

(21) Appl. No.: 12/459,522

(22) Filed: Jul. 1, 2009

Related U.S. Application Data
(60) Provisional application No. 61/134,402, filed on Jul. 10, 2008.

(51) Int. Cl. B05B 15/06

(52) U.S. Cl. 239/200

(57) ABSTRACT

The present invention describes a portable sprinkler riser mechanism that offers the location and stability of the stake type riser mechanisms, yet also provides the ease of placement and flexibility of the surface type riser mechanisms. This is accomplished through the use of a weighted impact hammer co-located with the riser.

This non-provisional utility patent application claims the benefit of priority for U.S. Provisional patent application No. 61/134,402 filed Jul. 10, 2008.

### BRIEF DESCRIPTION

The subject of this invention relates to the irrigation industry. Specifically, the present invention discloses a riser mechanism that allows the user to quickly and easily set the sprinkler in a stable physical position. A threaded end allows the user to place a variety of sprinkler head types on the riser.

### BACKGROUND OF THE INVENTION

Irrigation systems have been in general use for centuries. In the more recent past, both sub-surface, or buried systems, as well as surface systems have been used to irrigate crops, lawns and gardens. Common to all systems is a delivery source such as a pipe or hose, a transitional section, most commonly referred to as a riser, for coupling the irrigation distribution device to the source, and a distribution device such as a sprinkler head. As is known, sprinkler heads come is a wide variety of types and sizes depending upon the exact irrigation problem to be solved.

One common irrigation method in wide use, particularly in residential areas, is a surface mounted irrigation system comprised of a hose for the source, a hose coupling and base as the transitional mechanism, and some form of water dispersal device such as a spinner, a gear driven head, or an impact driven head. For simplification, the source, or delivery mechanism will be referred to as a hose, the transitional mechanism will be referred to a s a riser, and the dispersal mechanism will be referred to as a sprinkler head. It will be understood that these terms cover a wide spectrum of irrigation components and the intent of this application is to cover all theses devices within the ambit of the claims.

Among the many methods available to the user for surface irrigation are riser mechanisms that use a base that simply sits on the ground or risers that have one form or another of a stake to push into the ground. As described below, each of these prior art methods has undesirable features.

Regarding the type of riser that simply sits on the ground, any unwanted movement in the hose, for example, a child playing or a garden tool catching the hose, may cause the riser to tip over or, at a minimum, fail to irrigate the intended target. When this happens water is wasted and the user must reposition the riser and try again.

Regarding the stake type riser mechanism, while these do provide some level of physical stability, they can be difficult to place, especially in hard or uneven ground. Further complicating the problem, many of these types of risers are made of plastic, so any pressure placed upon the mechanism in order to secure it in the ground can damage or break either the stake or the riser/head combination.

What would be desirable would be a riser mechanism that provides the physical location and stability of the stake type riser mechanisms, yet offered the ease of placement and flexibility of the surface type riser mechanisms.

### SUMMARY OF THE INVENTION

The present invention describes a portable sprinkler riser mechanism that offers the ease of location and stability of the stake type riser mechanisms, yet also provides the ease of placement and flexibility of the surface type riser mechanisms. This is accomplished through the use of a weighted slide hammer co-located with the riser. The user simply places the riser mechanism where needed, then operates the impact hammer to drive a set of stakes into the ground.

A base plate is provided that has three short stakes located on the bottom surface with pointed ends suitable for driving into the ground. Attached to the top surface of the base plate is a vertical shaft. Concentric on the shaft is a weight which can be easily moved up and down and is sized such that a human hand can easily grasp it. The combination of the shaft and the weight form a slide hammer, or impact hammer as it is sometimes called. At the top end of the vertical shaft is a coupling suitable for attaching a standard garden hose. The coupling has a female hose connector for receiving the hose and a standard half inch male thread for receiving a variety of sprinkler head devices.

In operation, a user places the three short stakes at the location where the riser mechanism is to be used, then operates the weight up and down so as to hammer the stakes into the ground. Since the stakes are short, the entire riser mechanism is easily removed from a first location to a second location for the next use cycle.

The method and apparatus of the present invention offer several advantages over the prior art. Among these are ease of use and physical stability. As well as these advantages, the present invention has other advantages discussed in detail below in conjunction with the drawings and figures attached.

### BRIEF DESCRIPTION OF THE DRAWINGS

FIG. 1: is an overall view of the present invention.

FIG. 2: shows the weight in various positions demonstrating use of the present invention.

### DETAILED DESCRIPTION OF PREFERRED EMBODIMENTS

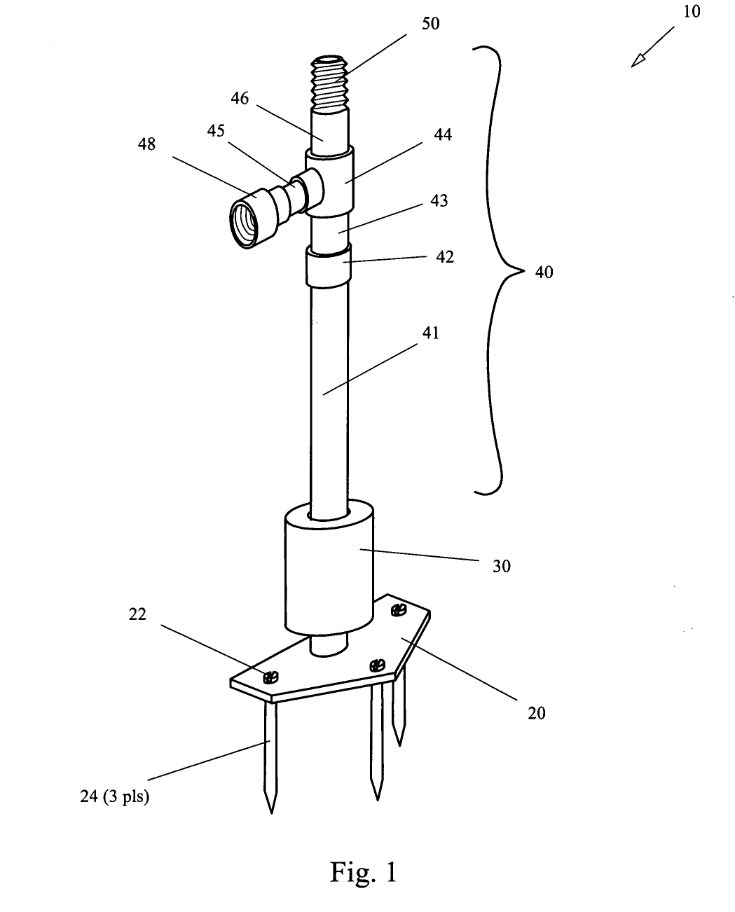

The apparatus of the present invention provides a user with the ability to quickly locate and physically restrain a surface type sprinkler riser. FIG. 1 shows an overview of the apparatus 10 of the present invention. A base plate 20 has three short spikes 24 attached to the bottom surface. In a preferred embodiment, the base plate 20 is made from steel, but it will be understood by those skilled in the art that other materials, such as aluminum or plastic, could be used without departing from the spirit of the invention. The base plate 20 in a preferred embodiment is approximately seven inches by four inches, with a thickness of three-sixteenths of an inch, and is shaped like the home plate at a baseball field. Of course other shapes and/or dimensions are possible, thus the invention is limited only by the claims.

In a preferred embodiment the spikes 24 are approximately four inches long and one quarter inch in diameter, with the end of the spikes opposite the base 20 terminating in a point. It will be recognized that although the stakes in the preferred embodiment are dimensioned as stated, other greater or lesser dimensions could be used without departing from the spirit of the invention. It will also be known to those of skill in the art that more or fewer spikes could be used while still adhering to the principles of the present invention. The spikes 24 in a preferred embodiment are also made from steel and are attached to the base 20 by screws 22. However, it will be known to those of skill in the art that other methods, for example rivets or welds, and other materials, may be used without departing from the spirit of the invention.

Attached to the top surface of the base 20 is a vertical shaft assembly 40. The vertical shaft assembly 40 is comprised of two sections: a bottom part 41 and a top part comprised of several individual pieces described in detail below. The top part and bottom part are coupled together by sleeve 42. The bottom part 41 in a preferred embodiment is made from a three eights solid steel bar approximately twelve inches in length. This is done so that no damage will occur to the bottom part 41 as the weight 30 is moved up and down. However, other materials, for example a one half inch aluminum bar, could be used as long as the selected material is able to withstand the action of the moving weight without damage.

Vertical shaft assembly 40 is attached to base plate 20 by means of a screw (not shown) and as with the spikes 24, other fastening means could be used without exceeding the ambit of the claims. For example, the shaft assembly 40 could have a male thread that mates with a female thread in the base plate 20, or in the alternative, a twist lock method such as used with many mechanical devices. The only restriction on the shaft is that it be able to withstand the sliding action of the weight without damage.

The top part of the vertical shaft assembly 40 is comprised of lower tube segment 43, tee connector 44, upper tube segment 46, lateral tube segment 45 and input fitting 48. The lower tube segment 43, tee connector 44, upper tube segment 46, and lateral tube segment 45 are all standard one half inch PVC [polyvinyl chloride] parts well known to those in the art. Further, upper tube segment 46 terminates in a standard male sprinkler head thread 50 which serves as the output fitting, also well understood in the art. As such, none of these parts are discussed in detail, but the lack of such a detailed discussion should not be read as a limitation on the scope of the invention.

The top part of the vertical shaft assembly 40 is mated with the bottom part 41 by means of a sleeve 42. In a preferred embodiment, the sleeve 42 is also a standard PVC part with a slip fitting on one end and a one half inch female pipe thread on the other. Bottom part 41 has a corresponding male pipe thread. Bottom part 41 is thus screwed into sleeve 42 and lower segment 43 is cemented into sleeve 42 in the customary manner.

A concentric weight 30 is fitted about the lower part 41. The weight 30 in a preferred embodiment is approximately three inches in diameter, with an approximately seven sixteenths inch hole through its vertical axis, and weighing approximately four pounds. The size and weight of the weight 30 have been selected to make the weight 30 easily moveable by a human hand. It will be recognized that other size and weight combinations could be used without departing from the spirit of the invention.

The input fitting 48 in a preferred embodiment is a standard three quarter inch female hose fitting. The output fitting 50, as discussed just above, is a standard one half inch male threaded riser. Both the input and output fittings are capable of receiving standard irrigation components such as a garden hose or a variety of sprinkler head types. For example, a gear-driven sprinkler head or an impact-driven sprinkler head. Of course other input and/or output fittings could be used without departing from the spirit of the invention.

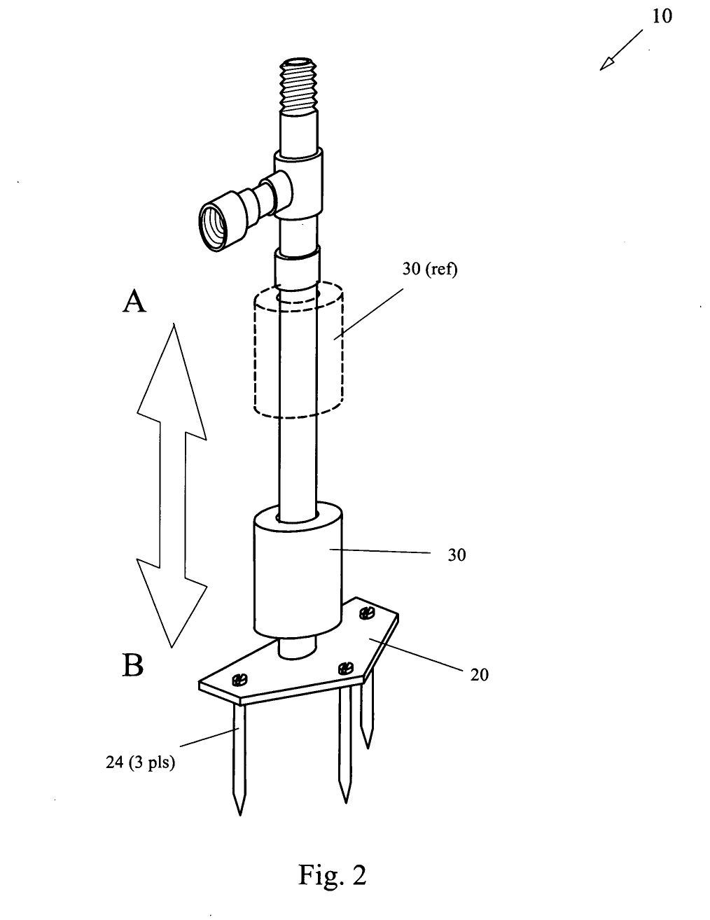

Looking now at FIG. 2, the present invention 10 is shown again, but this time to illustrate the method of use. After placing the present invention on the surface of the area to be irrigated, the user grasps the weight 30 and moves it up from position A toward position B. Once at position B, the weight 30 is moved downward toward position A in a rapid manner, such as the motion used for a hammer. Repeating this movement several times, and allowing the weight 30 to contact the base plate 20 will cause the stakes 24 to be driven into the ground, thereby providing secure physical location of the sprinkler riser with little effort.

A first advantage of the present invention is the ease with which a user can securely locate a sprinkler riser. This is so because, like many sprinkler mechanisms, the riser of the present invention is small, lightweight and thus very portable. By using the slide hammer weight, the spikes on the bottom of the present invention can be driven into the ground, thus preventing the sprinkler from migrating due to hose pressure or inadvertent dragging on the supply hose.

A second advantage of the present invention is the ability to quickly attach a variety if sprinkler head types, making the present invention adaptable to a wide variety of irrigation problems. The riser of the present invention has a standard male thread which accepts many different sprinkler head types.

A third advantage of the present invention is that no tools or accessories are required for a user to operate the apparatus. The integral slide hammer mechanism provides the requisite force needed to set the apparatus in a stable position.

A fourth advantage of the present invention is that the three spikes form a tripod. This has the benefit of making it very easy to locate the apparatus on uneven ground, for example, in the presence of mole hills or berms.

I claim:

1. An apparatus for securely locating a portable sprinkler riser, comprising:
a base plate, said base plate being a five sided polygon with an upper surface and a lower surface and further comprised of two 90 degree angles and three 60 degree angles such that two of said 60 degree angles are adjacent to parallel sides of said polygon and the third of said 60 degree angles forms an apex opposite the base of said polygon;
a set of three spikes affixed to the bottom surface of said base plate and disposed downward from said lower surface of said base plate such that a first of said spikes is located at said apex of said polygon, the second of said spikes is located at one junction of said base of said polygon and a first of said parallel sides of said polygon and the third of said spikes is located at the opposite corner of said base and second of said parallel sides, said three spikes having pointed ends, and;
a vertical shaft formed by an upper part and a lower part, said lower part of said vertical shaft having a concentric weight arranged about it such that said weight is free to move along the center axis of said lower part and wherein said upper part has an input fitting and an output fitting.

2. The apparatus of claim 1 wherein the base plate, the spikes, the lower part of the vertical shaft and the concentric weight are made from steel and wherein the upper part of said vertical shaft is made from PVC.

3. The apparatus of claim 1 wherein the input fitting is a female hose coupling and the output fitting is a standard half inch male sprinkler thread.
